(19) United States
(12) Patent Application Publication
(10) Pub. No.: US 2025/0042093 A1
(43) Pub. Date: Feb. 6, 2025

(54) METHOD AND APPARATUS FOR DETECTING PRINT QUALITY OF 3D PRINTER AND 3D PRINTER

(71) Applicant: SHANGHAI LUNKUO TECHNOLOGY CO., LTD., SHANGHAI (CN)

(72) Inventors: Wei WU, SHANGHAI (CN); Ketan TANG, SHANGHAI (CN)

(73) Assignee: SHANGHAI LUNKUO TECHNOLOGY CO., LTD., SHANGHAI (CN)

(21) Appl. No.: 18/925,065

(22) Filed: Oct. 24, 2024

Related U.S. Application Data
(63) Continuation of application No. PCT/CN2023/090131, filed on Apr. 23, 2023.

(30) Foreign Application Priority Data
Apr. 24, 2022 (CN) 202210435067.2

(51) Int. Cl. B29C 64/393; B33Y 30/00; B33Y 50/02

(52) U.S. Cl. CPC B29C 64/393; B33Y 30/00; B33Y 50/02

(57) ABSTRACT

The present disclosure provides a method for detecting the print quality of a 3D printer. The method comprises: acquiring a model reference map; generating a scanning path; moving a depth sensor along the scanning path under the carriage of a printing head, and obtaining a first local depth map sequence based on measurements by the depth sensor at multiple different locations during the movement; printing a first layer of a 3D model on a hot bed using the printing head; moving the depth sensor along the scanning path under the carriage of the printing head, and obtaining a second local depth map sequence based on measurements by the depth sensor at the multiple different locations during the movement; and determining a print quality result.

### CROSS-REFERENCE TO RELATED APPLICATION

This application is a continuation of International Patent Application No. PCT/CN2023/090131, filed on Apr. 23, 2023, which claims priority to Chinese Patent Application No. 202210435067.2, filed on Apr. 24, 2022. The disclosures of the aforementioned applications are hereby incorporated by reference in their entireties.

### TECHNICAL FIELD

The present disclosure relates to the field of 3D printing technologies, and in particular to a method for detecting the print quality of a 3D printer, an apparatus for detecting the print quality of a 3D printer, a 3D printer, a computer-readable storage medium, and a computer program product.

### BACKGROUND

3D printing technology, also known as additive manufacturing, is a technique for constructing objects by layer-by-layer printing using bondable materials based on digital model files. 3D printing is typically achieved by using a 3D printer. A 3D printer, also known as a three-dimensional printer or an additive manufacturing device, is a process equipment for rapid prototyping. 3D printers are commonly used in fields such as mold manufacturing and industrial design to produce models or components. A typical 3D printing technology is Fused Deposition Modeling (FDM), which builds objects by selectively depositing melted materials layer by layer along predetermined paths, using materials of thermoplastic polymers in filament form. There is still significant room for improvement in the print quality of current 3D printers.

The methods described in this section are not necessarily methods that have been previously conceived or pursued. Unless otherwise indicated, it should not be assumed that any of the methods described in this section qualify as prior art merely by virtue of their inclusion in this section.

Similarly, unless otherwise indicated, the problems mentioned in this section should not be considered as having been acknowledged in any prior art.

### SUMMARY

The present disclosure provides a method for detecting the print quality of a 3D printer, an apparatus for detecting the print quality of a 3D printer, a 3D printer, a computer-readable storage medium, and a computer program product.

According to an aspect of the present disclosure, a method for detecting the print quality of a 3D printer is provided. The 3D printer comprises a hot bed, a printing head movable relative to the hot bed, a depth sensor arranged on the printing head for measuring a distance of part of the hot bed relative to the depth sensor, and at least one processor for obtaining a local depth map of the part of the hot bed based on a measurement result from the depth sensor and controlling movement of the printing head relative to the hot bed based on control codes generated by slicing software to print a 3D model layer by layer. The method comprises: acquiring a model reference map, wherein the model reference map represents an occupied region of at least part of a first layer of the 3D model on the hot bed; generating a scanning path based on the model reference map; moving the depth sensor along the scanning path under the carriage of the printing head, and obtaining a first local depth map sequence based on measurements by the depth sensor at the multiple different locations during the movement; printing the first layer of the 3D model on the hot bed using the printing head; moving the depth sensor along the scanning path under the carriage of the printing head, and obtaining a second local depth map sequence based on measurements by the depth sensor at the multiple different locations during the movement; generating a global depth map corresponding to the model reference map, wherein the global depth map is filled with respective height values at multiple coordinates corresponding to the multiple different locations, the respective height values being respective heights of the first layer of the 3D model at the multiple different locations, and being difference values between various local depth maps in the first local depth map sequence and corresponding local depth maps in the second local depth map sequence; and determining a print quality result based on the model reference map, a print height set by the slicing software for the first layer of the 3D model, and the global depth map, wherein the print quality result indicates the print quality of the at least part of the first layer of the 3D model,
wherein the scanning path is generated so that when the depth sensor moves along the scanning path as the printing head moves relative to the hot bed, the depth sensor sequentially measures distances of multiple different locations of the occupied region relative to the depth sensor;
wherein the first local depth map sequence indicates respective distances of the multiple different locations relative to the depth sensor;
wherein the second local depth map sequence indicates respective distances of the multiple different locations relative to the depth sensor after the first layer of the 3D model has been printed on the hot bed; and
wherein, optionally, the respective height values are obtained through the difference values between the various local depth maps in the first local depth map sequence and the corresponding local depth maps in the second local depth map sequence.

According to another aspect of the present disclosure, an apparatus for detecting the print quality of a 3D printer is provided. The 3D printer comprises a hot bed, a printing head movable relative to the hot bed, a depth sensor arranged on the printing head for measuring a distance of part of the hot bed relative to the depth sensor, and at least one processor for obtaining a local depth map of the part of the hot bed based on a measurement result from the depth sensor and controlling movement of the printing head relative to the hot bed based on control codes generated by slicing software to print a 3D model layer by layer. The apparatus comprises a first module for acquiring a model reference map, wherein the model reference map represents an occupied region of at least part of a first layer of the 3D model on the hot bed; a second module for generating a scanning path based on the model reference map; a third module for moving the depth sensor along the scanning path under the carriage of the printing head, and obtaining a first local depth map sequence based on measurements by the depth sensor at the multiple different locations during the movement; a fourth module for printing the first layer of the 3D model on the hot bed using the printing head; a fifth module for moving the depth sensor along the scanning path under the carriage of the printing head, and obtaining a second local depth map sequence based on measurements by the depth sensor at the multiple different locations during the movement; a sixth module for generating a global depth map corresponding to the model reference map, wherein the global depth map is filled with respective height values at multiple coordinates corresponding to the multiple different locations, the respective height values being respective heights of the first layer of the 3D model at the multiple different locations, and being difference values between various local depth maps in the first local depth map sequence and corresponding local depth maps in the second local depth map sequence; and a seventh module for determining a print quality result based on the model reference map, a print height set by the slicing software for the first layer of the 3D model, and the global depth map, wherein the print quality result indicates the print quality of the at least part of the first layer of the 3D model.

According to another aspect of the present disclosure, a 3D printer is provided, comprising a hot bed, a printing head movable relative to the hot bed, a depth sensor arranged on the printing head for measuring a distance of part of the hot bed relative to the depth sensor, and at least one processor configured to obtain a local depth map of the part of the hot bed based on a measurement result from the depth sensor, and control movement of the printing head relative to the hot bed based on control codes generated by slicing software to print a 3D model layer by layer, wherein the at least one processor is further configured to execute instructions to implement the method described above.

According to another aspect of the present disclosure, a non-transitory computer-readable storage medium storing instructions is provided, wherein the instructions, when executed by the at least one processor of the 3D printer described above, cause the 3D printer to implement the method described above.

According to another aspect of the present disclosure, a computer program product comprising instructions is provided, wherein the instructions, when executed by the at least one processor of the 3D printer described above, cause the 3D printer to implement the method described above.

It should be understood that what is described in this section is not intended to identify key or critical features of embodiments of the present disclosure, and it is also not intended to limit the scope of the present disclosure. Other features of the present disclosure will become apparent from the following description.

### BRIEF DESCRIPTION OF THE DRAWINGS

The accompanying drawings exemplarily illustrate the embodiments and constitute a part of the specification, and they are used together with the textual description of the specification to explain the exemplary embodiments. The illustrated embodiments are provided for illustrative purposes only and do not limit the scope of the claims. In all the accompanying drawings, the same reference numerals refer to similar, but not necessarily identical, elements.

FIG. 1 illustrates a schematic diagram of a 3D printer according to an exemplary embodiment;

FIG. 2 illustrates the working principle of a laser profilometer composed of a laser projector and a camera within the 3D printer of FIG. 1;

FIG. 3 illustrates a flowchart of a method for detecting the print quality of a 3D printer according to an exemplary embodiment;

FIG. 4 illustrates an exemplary graphical representation of a first layer of a 3D model on a hot bed;

FIG. 5 illustrates a model reference map corresponding to the example of FIG. 4;

FIG. 6 illustrates an example of a scanning path for the model reference map of FIG. 5;

FIG. 7 illustrates an example of a first local depth map and a second local depth map at a corresponding location;

FIG. 8 illustrates an example of a global depth map; and

FIG. 9 illustrates a structural block diagram of an apparatus for detecting the print quality of a 3D printer according to an exemplary embodiment.

### DETAILED DESCRIPTION

The following description is provided with reference to the accompanying drawings to explain exemplary embodiments of the present disclosure, including various details of the embodiments of the present disclosure to aid in understanding. These descriptions should be construed as illustrative only. Similarly, for clarity and conciseness, the descriptions below omit explanations of well-known functions and structures.

In the present disclosure, unless otherwise specified, the terms “first”, “second”, etc., are used for describing various elements and are not intended to define a location relationship, a temporal relationship, or an importance relationship of these elements, and such terms are used only for distinguishing one element from another. In some examples, a first element and a second element may refer to the same instance of the element, while in some cases they may refer to different instances based on the context of the description.

The terms used in the description of the various described examples in the present disclosure are for the purpose of describing particular examples only and are not intended to be limiting. Unless otherwise clearly indicated in the context, if the number of elements is not specifically limited, there may be one or a plurality of elements. Further, the term “and/or” used herein encompasses any one of and all possible combinations of the listed items. The term “based on” should be construed as “based, at least in part, on”.

3D printing technology constructs objects by printing them layer by layer. During 3D printing, the print quality of the first layer of a 3D model is crucial for determining the success of the print. If the print quality of the first layer is poor, it will significantly affect the quality of the finally formed 3D model. Therefore, it is essential to detect the print quality of the first layer to allow users to stop printing promptly if any issues arise regarding the first layer. Current 3D printers lack a first-layer quality detection function, making them unable to perceive first-layer quality issues.

The inventor has realized that depth detection technology could be used to detect the print quality of the first layer. Moreover, compared to other quality detection technologies (such as detecting the presence of printing voids with optical cameras), depth detection technology possesses higher detection precision and applicability to more types of printing materials.

The embodiments of the present disclosure will be described in detail below with reference to the accompanying drawings.

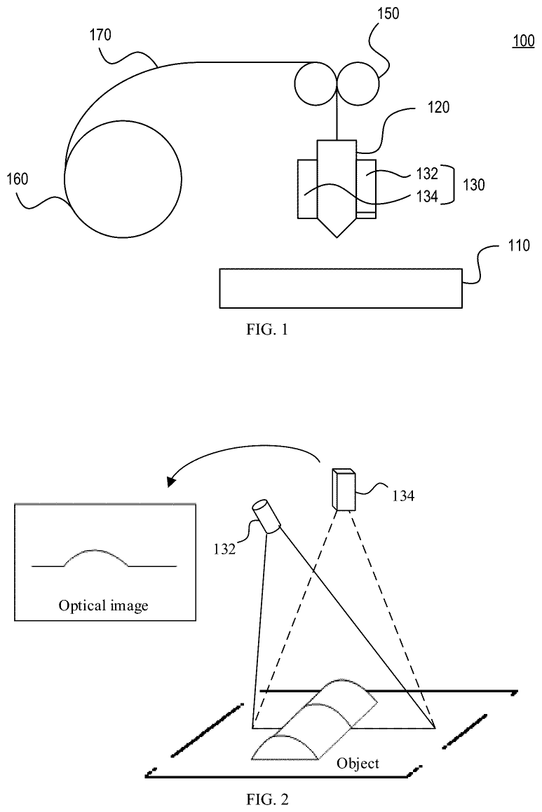

FIG. 1 illustrates a schematic diagram of a 3D printer 100 according to an embodiment of the present disclosure. As shown in FIG. 1, the 3D printer 100 comprises a hot bed 110, a printing head 120 movable relative to the hot bed 110, and a depth sensor 130 arranged on the printing head 120 for measuring the distance of part of the hot bed 110 relative to the depth sensor 130. Here, the phrase “printing head movable relative to the hot bed” may refer to any one of the following scenarios: (1) the hot bed remains stationary while the printing head moves; (2) the hot bed moves while the printing head remains stationary; or (3) both the hot bed and the printing head move. Examples of the depth sensor 130 comprise but are not limited to laser range finders, time-of-flight (TOF) depth cameras, stereo vision based depth cameras, structured light depth cameras, and laser profilometers.

In the example shown in FIG. 1, the depth sensor 130 is illustrated as a laser profilometer comprising a laser projector 132 and a camera 134. For ease of description herein, such a laser profilometer is used as an example to explain the embodiments of the present disclosure, but the present disclosure is not limited in this regard.

The laser projector 132 may be a line laser or a surface laser (e.g., a vertical cavity surface emitting laser (VCSEL)). In the case of a line laser, the 3D printer 100 may comprise more than one line laser. For example, the 3D printer 100 may comprise two line lasers, with the laser lines emitted by the two line lasers intersecting on the hot bed 110, thereby allowing for print quality detection of 3D models with different orientations. The camera 134 is generally a 2D optical camera. The laser projector 132 and the camera 134 are arranged at a certain angle relative to each other. Common arrangements include: (1) the laser projector 132 is arranged tilted relative to the horizontal plane, projecting the laser obliquely onto the object being measured, while the camera 134 is arranged facing directly downwards; (2) the laser projector 132 is arranged facing directly downwards, while the camera 134 is arranged tilted relative to the horizontal plane; or (3) both the laser projector 132 and the camera 134 are arranged tilted relative to the horizontal plane. With the laser profilometer composed of the laser projector 132 and the camera 134, the distance between the hot bed 110 and the camera 134 can be measured, which will be further described later.

The 3D printer 100 further comprises at least one processor (not shown). The at least one processor is used to control the movement of the printing head 120 relative to the hot bed 110 based on control codes generated by slicing software to print a 3D model layer by layer. As shown in FIG. 1, the at least one processor may drive a motor (not shown), which in turn drives extrusion wheels 150 to feed the printing material 170 from a filament spool 160 to the printing head 120. During the movement of the printing head 120, the printing material is extruded from the printing head 120 and deposited onto the hot bed 110. Typically, the slicing software runs on a computing device that is communicatively connected to the 3D printer 100 and operates to generate control information for the controlling of the printing process. For example, the slicing software may provide a graphical user interface (GUI) that allows users to select or adjust layout information representing the location and orientation of the 3D model on the hot bed 110. The slicing software may slice the 3D graphical representation of the 3D model to generate slice data (e.g., number of slices, height of each slice layer), and then transform the slice data into control codes for controlling the printing head 120 of the 3D printer 100 to move along the printing path to print each layer of slices. Such control codes are typically in the form of G-code. The control codes are downloaded to the 3D printer 100 for execution by the at least one processor. For this purpose, the 3D printer 100 may further comprise at least one memory (not shown) for storing programs and/or data.

The at least one processor is further used to obtain a local depth map of the part of the hot bed 110 based on the measurement result from the depth sensor 130. In the case where the depth sensor 130 is a combination of the laser projector 132 and the camera 134, the laser projector 132 projects a laser onto the hot bed 110, and the at least one processor obtains a local depth map of the part of the hot bed 110 illuminated by the laser based on the optical image of the projected laser on the hot bed 110 captured by the camera 134. FIG. 2 illustrates the working principle of the laser profilometer composed of the laser projector 132 and the camera 134. In the example shown in FIG. 2, the laser projector 132 is a line laser and is arranged tilted relative to the horizontal plane, while the camera 134 is arranged facing directly downwards. The laser projector 132 projects a laser line, forming a laser plane in three-dimensional space. The laser plane intersects with the object to be measured (in this example, a curved protrusion), forming a curve. After capturing the curve, the camera 134, using the principle of triangulation, may determine the coordinates of each point on the curve in the camera coordinate system of the camera 134, including the distance (also known as depth) of the point from the camera 134. In this way, a local depth map corresponding to the laser line is obtained. It should be understood that the arrangement shown in FIG. 2 is illustrative rather than restrictive. In other embodiments, other arrangements may be used. For example, a surface laser may be used, where the laser plane projected onto the object being measured may be considered as a collection of multiple laser lines. Consequently, distances from points on the multiple laser lines to the camera 134 can be measured. The measurement may also be based on the principle of triangulation. The principle of triangulation is a well-known technique, and it will not be described in detail here to avoid obscuring the subject matter of the present disclosure.

The at least one processor is also used to implement various functions described below. In the example, the processor comprises a microcontroller or computer that executes instructions stored in firmware and/or software (not shown). The processor may be programmable to perform the functions described herein. As used herein, the term “computer” is not limited to the integrated circuits referred to as computers in the art, but broadly refers to computers, processors, microcontrollers, microcomputers, programmable logic controllers, application-specific integrated circuits, and other programmable circuits. These terms may be used interchangeably herein. The computers and/or processors discussed herein may each use computer-readable media or machine-readable media, which refer to any media involved in providing instructions to the processor for execution. The memory discussed above constitutes computer-readable media. Such media may take various forms, including but not limited to non-volatile media, volatile media, and transmission media.

It should be understood that the exemplary embodiments of the present disclosure are described below in conjunction with an FDM printer, but the present disclosure is not limited to FDM printers.

In the embodiments, the printing head 120 may be configured to be capable of extruding any material suitable for 3D printing, including, for example, thermoplastics, alloys, metal powders, ceramic materials, ceramic powders, and polymers.

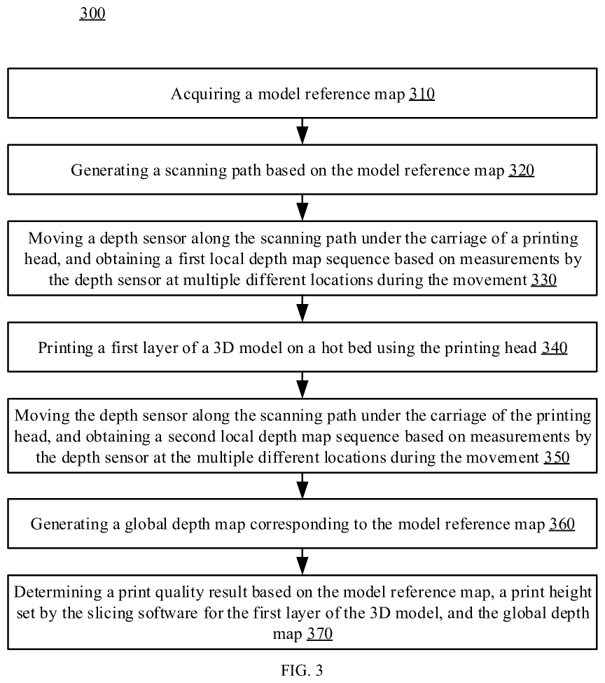

FIG. 3 is a flowchart illustrating a method 300 for detecting the print quality of a 3D printer according to an exemplary embodiment. For the purpose of discussion, the method 300 will be described below in conjunction with the 3D printer 100 shown in FIG. 1. In the example, the method 300 may be implemented by the at least one processor in the 3D printer 100.

At step 310, a model reference map is acquired. The model reference map represents the occupied region of at least part of the first layer of a 3D model on the hot bed 110.

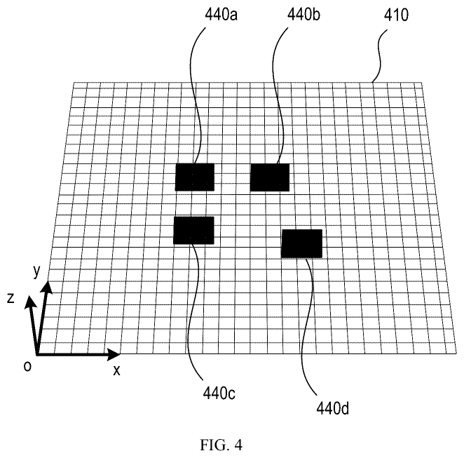

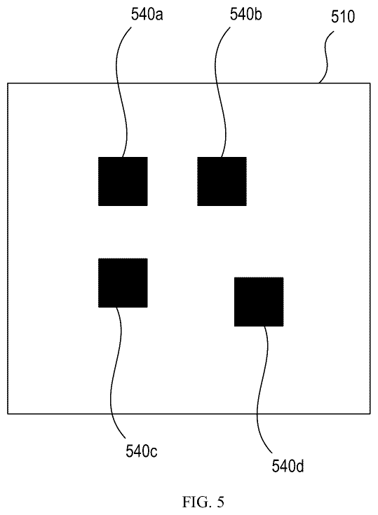

The model reference map will be explained below in conjunction with FIGS. 4 and 5. FIG. 4 illustrates an exemplary graphical representation of the first layer of a 3D model on the hot bed 410, and FIG. 5 illustrates the model reference map corresponding to the example of FIG. 4. In the example, the occupied region of the first layer of the 3D model on the hot bed 410 comprises four discrete regions: 440a, 440b, 440c, and 440d. These regions may be formed from the same printing material or different printing materials. Although the discrete regions 440a, 440b, 440c, and 440d are shown in FIG. 4 as having rectangular shapes, this is illustrative only. In other examples, the occupied region of the first layer of the 3D model may have other shapes or configurations (such as a single connected region), and the present disclosure is not limited in this regard. Corresponding to the graphical representation in FIG. 4, the model reference map 510 comprises four pixel regions: 540a, 540b, 540c, and 540d, as shown in FIG. 5. Generally, the model reference map 510 may be generated in the coordinate system oxyz of the hot bed (FIG. 4), and the coordinates of the pixel regions 540a, 540b, 540c, and 540d in the model reference map 510 correspond one-to-one with the coordinates of the discrete regions 440a, 440b, 440c, and 440d on the hot bed 410. It should be understood that while the model reference map 510 is illustrated in FIG. 5 with dimensions corresponding to those of the hot bed 410 in FIG. 4, this is not necessary. In other examples, the model reference map 510 may only have dimensions corresponding to the bounding box of the occupied region (in FIG. 4, the collective discrete regions 440a, 440b, 440c, and 440d), thereby saving storage space.

It should also be understood that the model reference map does not necessarily need to represent the entire first layer of the 3D model; the model reference map may represent only part of the first layer of the 3D model. This is because, in some cases, it may be sufficient to detect the print quality of only part of the first layer of the 3D model. For example, due to uneven temperature distribution of the hot bed, some hot bed regions may have higher temperatures while other hot bed regions may have lower temperatures. In hot bed regions with lower temperatures, the printing material may not form properly, leading to printing defects. In such cases, it is feasible to only detect check the print quality in hot bed regions with lower temperatures, thereby improving detection efficiency.

The model reference map may be generated by parsing the control information generated by slicing software. In some embodiments, the control information generated by the slicing software comprises control codes (e.g., G-code) used for printing the first layer of the 3D model. In such embodiments, acquiring the model reference map (step 310) may comprise: receiving the model reference map from a computing device communicatively connected to the 3D printer 100. The model reference map is generated by the slicing software running on the computing device by parsing the control codes used for printing the first layer of the 3D model. Alternatively, acquiring the model reference map (step 310) may comprise: reading the model reference map locally from the 3D printer 100.

The model reference map is generated by the at least one processor by parsing the control codes used for printing the first layer of the 3D model. Since the control codes specify the motion path of the printing head, it is possible to recover the occupied region of the first layer of the 3D model on the hot bed from the codes.

In some embodiments, the control information generated by the slicing software comprises layout information representing the location and orientation of the 3D model on the hot bed 110. In such embodiments, acquiring the model reference map (step 310) may comprise: receiving the model reference map from a computing device communicatively connected to the 3D printer 100. The model reference map is generated by the slicing software running on the computing device by parsing the layout information. Since the layout information defines the location and orientation of the 3D model on the hot bed, it is possible to recover the occupied region of the first layer of the 3D model on the hot bed from the information.

Referring back to FIG. 3, at step 320, a scanning path is generated based on the model reference map. The scanning path is generated so that when the depth sensor 130 moves along the scanning path as the printing head 120 moves relative to the hot bed 110, the depth sensor 130 sequentially measures the distances of multiple different locations of the occupied region relative to the depth sensor 130.

FIG. 6 illustrates an example of a scanning path for the model reference map of FIG. 5. In some embodiments, the occupied region comprises at least one discrete region spaced apart from each other, and the model reference map comprises at least one pixel region respectively representing the at least one discrete region. Moreover, generating the scanning path (step 320) may comprise the following operations:

(1a) The respective bounding boxes for the at least one pixel region are determined to obtain at least one bounding box respectively corresponding to the at least one pixel region. In the example of FIG. 6, the respective bounding boxes for pixel regions 540a, 540b, 540c, and 540d may be determined, thereby resulting in four bounding boxes.

(1b) A scanning path is determined in the model reference map, and a virtual box representing the field of view (FOV) of the depth sensor moves along the scanning path to cover part of the at least one bounding box as a whole each time, eventually traversing the entire region of the at least one bounding box. In the example of FIG. 6, a virtual box representing the FOV of the camera 134 is illustrated, and the determined scanning path is illustrated with the hollow arrows. In the example, the scanning path is a Zig-Zag path, but this is illustrative rather than restrictive.

It should be understood that the operation to generate a bounding box is not mandatory. In some embodiments, the scanning path may be generated based on the original shape of the pixel region representing the occupied region of the first layer of the 3D model on the hot bed in the model reference map. In other embodiments, the scanning path may also be generated using any other appropriate method, as long as the depth sensor can measure multiple target locations of the occupied region of the first layer of the 3D model on the hot bed.

In some embodiments, the occupied region comprises at least one discrete region spaced apart from each other, and the model reference map comprises at least one pixel region respectively representing the at least one discrete region. Moreover, generating the scanning path (step 320) may comprise the following operations:

(2a) The respective connected components for the at least one pixel region are determined to obtain at least one connected component respectively corresponding to the at least one pixel region. In the example of FIG. 6, the respective connected components for the pixel regions 540a, 540b, 540c, and 540d may be determined, thereby obtaining four connected components.

(2b) For each connected component, a movement path is determined in the model reference map, and a virtual box representing the FOV of the depth sensor moves along the movement path to cover part of the connected component each time, eventually traversing the entire region of the connected component. This may be similar to the operation (1b) described above and will not be reiterated here.

(2c) The movement paths for all connected components are merged into one merged path to serve as the scanning path. By generating separate scanning paths for each discrete region of the occupied region and merging these separate scanning paths into a final scanning path, the scanning of non-target regions (such as the blank regions in FIG. 6) can be reduced, thereby improving the detection efficiency.

It should be understood that, in the embodiments, the scanning path is generated based on the FOV of the depth sensor 130 (e.g., the FOV of the camera 134), while the scanning path of the depth sensor 130 does not necessarily coincide with the movement path of the printing head 120, as there may be rotations and/or translations between the orientations of the depth sensor 130 and the printing head 120. By using extrinsic calibration, the rotation and/or translation between the printing head 120 and the depth sensor 130 in a three-dimensional coordinate system (e.g., the coordinate system of the hot bed) may be pre-calibrated; the scanning path for the depth sensor 130 is transformed to the movement path for the printing head 120; and corresponding control codes are generated to control the movement of the printing head 120, thus enabling the depth sensor 130 to move along the scanning path under the carriage of the printing head 120. Extrinsic calibration is a well-known technique, and it will not be described in detail here to avoid obscuring the subject matter of the present disclosure.

Referring back to FIG. 3, at step 330, the depth sensor 130 is moved along the scanning path under the carriage of the printing head 120, and a first local depth map sequence is obtained based on measurements by the depth sensor 130 at the multiple different locations on the hot bed 110 during the movement. The first local depth map sequence indicates the respective distances of the multiple different locations relative to the depth sensor 130.

In some implementations, according to the physical coordinates of the printing head 120 in the hot bed coordinate system when the camera 134 captures each optical image along the scanning path, the various first local depth maps in the first local depth map sequence are numbered and stored in memory. The purpose of numbering is to ensure that the various first local depth maps can correspond to the multiple different locations on the hot bed 110. It should be understood that the first local depth maps may be stored either in the camera coordinate system or transformed and stored in the image coordinate system. The following explanation uses storage in the camera coordinate system as an example.

At step 340, the printing head 120 prints the first layer of the 3D model on the hot bed 110.

At step 350, the depth sensor 130 is moved along the scanning path under the carriage of the printing head 120, and a second local depth map sequence is obtained based on measurements by the depth sensor 130 at the multiple different locations on the hot bed 110 during the movement. The second local depth map sequence indicates the respective distances of the multiple different locations relative to the depth sensor 130 after the first layer of the 3D model has been printed on the hot bed 110. This step allows the depth sensor 130 to scan again along the same scanning path as in step 330.

Similarly, in some implementations, according to the physical coordinates of the printing head 120 in the hot bed coordinate system when the camera 134 captures each optical image along the scanning path, the various second local depth maps in the second local depth map sequence may be numbered and stored in memory in the camera coordinate system. This ensures that the various second local depth maps can correspond to the multiple different locations on the hot bed 110 and, therefore, correspond to the various first local depth maps stored in step 330.

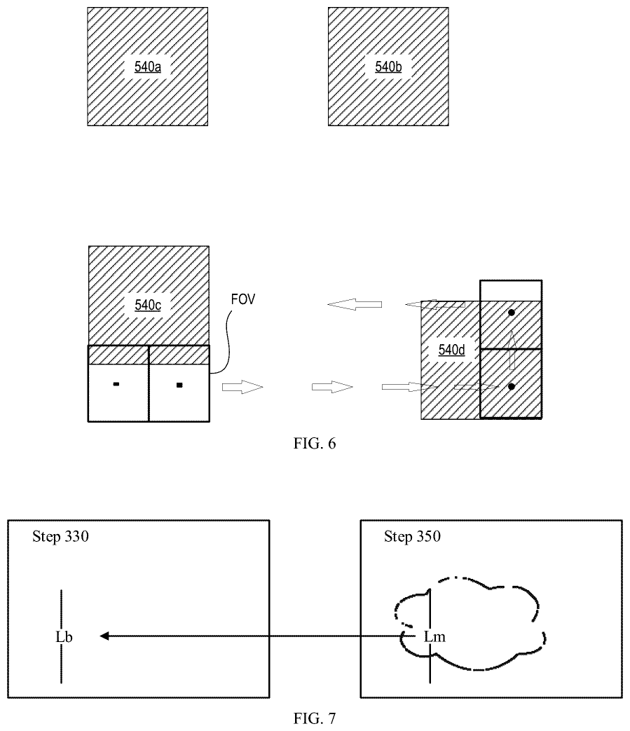

FIG. 7 illustrates an example of a first local depth map Lb and a second local depth map Lm at a corresponding location. In the example shown in FIG. 7, by determining the difference value between the first local depth map Lb and the second local depth map Lm, the height of the first layer of the 3D model at the location may be obtained. It should be understood that FIG. 7 is merely a visual representation of the depth map; the depth map itself may be a point cloud of three-dimensional coordinates, and each point in the point cloud may be considered a pixel of the depth map.

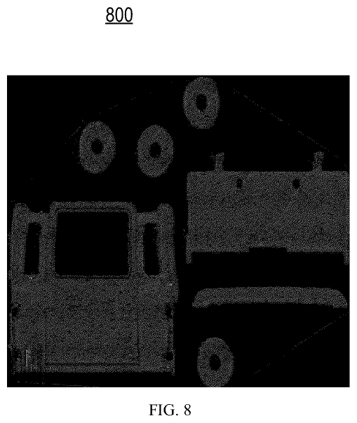

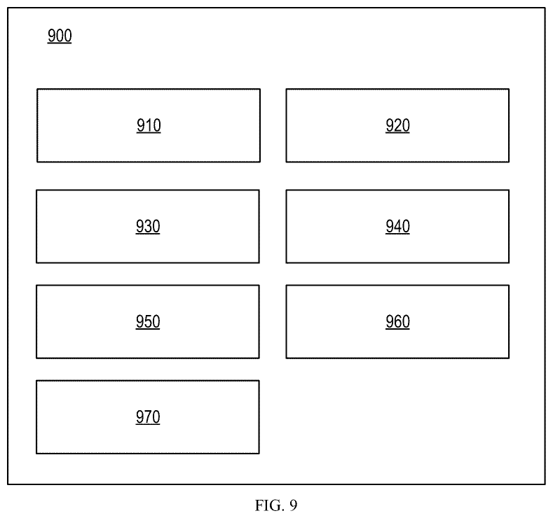

Referring back to FIG. 3, at step 360, a global depth map corresponding to the model reference map 510 is generated. The global depth map is filled with respective height values at multiple coordinates corresponding to the multiple different locations on the hot bed 110. The respective height values are the respective heights of the first layer of the 3D model at the multiple different locations and are the difference values between the various local depth maps in the first local depth map sequence and the corresponding local depth maps in the second local depth map sequence. FIG. 8 illustrates an example 800 of a global depth map.

In some embodiments, generating the global depth map corresponding to the model reference map (step 360) may comprise the following operations:

(3a) Multiple first coordinates representing the multiple different locations from the first local depth map sequence or the second local depth map sequence are respectively transformed to multiple second coordinates in the coordinate system where the model reference map is located. Continuing from the previous example (where the first local depth maps and the second local depth maps are stored in the camera coordinate system), the coordinates of the first local depth map sequence or the second local depth map sequence in the camera coordinate system may be respectively transformed to coordinates in the coordinate system where the model reference map is located (e.g., the hot bed coordinate system). The coordinate transformation matrix may be obtained through intrinsic calibration. Intrinsic calibration is a well-known technique, and it will not be described in detail here to avoid obscuring the subject matter of the present disclosure.

(3b) A blank depth map in the coordinate system where the model reference map is located is generated. In the example where the model reference map is in the hot bed coordinate system, a blank depth map may be generated in the hot bed coordinate system. As previously described, a depth map may be a point cloud of three-dimensional coordinates (e.g., in the form of a three-dimensional matrix), where each point may have three dimensions of x, y, and z. Here, x and y represent the plane coordinates on the xy plane in the hot bed coordinate system, and z represents the height value in the z direction in the hot bed coordinate system. It can be understood that in the blank depth map, the z dimension has no data (or may be filled with zeros).

(3c) The respective height values are filled at the multiple second coordinates in the blank depth map to obtain the global depth map. This can be considered as stitching the local depths together to form the global depth map 800.

Referring back to FIG. 3, at step 370, the print quality result is determined based on the model reference map, the print height set by the slicing software for the first layer of the 3D model, and the global depth map. The print quality result indicates the print quality of the at least part of the first layer of the 3D model.

It should be understood that the model reference map 510 and the print height set by the slicing software indicate the target print heights at the multiple different locations on the hot bed 110, while the global depth map 800 indicates the actual print heights at the multiple different locations.

Therefore, it is possible to detect the presence of printing defects or the severity of printing defects based on the error between the target value and the actual value of the print height. In some embodiments, determining the print quality result (step 370) comprises the following operations:

(4a) comparing the target print heights at the multiple different locations with the actual print heights at the corresponding locations in the multiple different locations; and

(4b) determining the print quality result based on the comparison.

It should also be understood that the error between the target value and the actual value may be measured through various possible methods, thereby determining the print quality result.

Hereinafter, some illustrative implementations are provided, which should not be considered limiting.

In some embodiments, the determination of the print quality result (step 370) mentioned above may further comprise:

(5a) The normal height range of the first layer of the 3D model is determined, with the upper and lower bounds of the normal height range being related (e.g., proportional) to the set print height.

Due to the different characteristics of different printing materials, assuming that the height of the first layer is set to 0.2 mm, the actual measured height may not necessarily be 0.2 mm (generally slightly lower), so it is necessary to determine the normal height range. In some implementations, operation (5a) may comprise:

(5a-1) A default height range is determined based on the set print height, with the upper and lower bounds of the default height range being a function of the set print height. In the example, the set print height is h, and the default height range is [h₀, h₁], where the lower bound h₀=0.3h and the upper bound h₁=2h. It should be noted that such a default height range is illustrative rather than restrictive. In other implementations, the upper and lower bounds h₀ and h₁ of the default height range [h₀, h₁] may be other appropriate functions of the set print height h.

(5a-2) A set of pixels in the global depth map is determined, and the set of pixels comprises all pixels with height values within the default height range [h₀, h₁].

(5a-3) The average height value h̅ of the set of pixels is calculated.

(5a-4) The upper and lower bounds h₀ and h₁ are updated by substituting the average height value h̅ as h into the function (in the example of 5a-1, h₀=0.3h and upper bound h₁=2h). The default height range with the updated upper and lower bounds h₀ and h₁ is the normal height range.

In some implementations, in the case that the printing material has been pre-calibrated (e.g., with a pre-calibrated ratio range between the measured height of the printing material and the print height), the normal height range may be directly determined using the calibration information of the printing material. In such implementations, operation (5a) comprises: determining the normal height range based on the set print height and the calibration information of the printing material, where the calibration information of the printing material specifies the functional relationship between the upper and lower bounds of the normal height range and the set print height. It should be understood that different printing materials may have different calibration information, so for the same set print height, different printing materials may have different normal height ranges.

In some embodiments, interpolation may be performed on the global depth map to increase the number of pixels with height values. In some cases, the original global depth map is relatively sparse, for example, due to large intervals between measurement locations of the depth sensor along the scanning path and/or voids in the measurement data of the depth sensor. This is unfavorable for the defect detection algorithm, so interpolation may be performed on the original global depth map.

Here, various interpolation methods may be used, with linear interpolation being the simplest. In the example, for a global depth map obtained by scanning in the column direction, all rows of the global depth map may be traversed. If a pixel D(x) in the global depth map does not have a height value, but there are effective pixels D(x₀), D(x₁) with height values within a certain range (e.g., 30 pixels) to its left and right, then the estimated value for D(x) is:

$$D ( x ) = ( ( x - {x}_{0} ) D {x}_{1} ) + ( {x}_{1} - x ) D ( {x}_{0} ) ) / ( {x}_{1} - {x}_{0} )$$

It should be understood that interpolation is not mandatory. For example, in the case of using a surface laser in the depth sensor, the effective pixels in the global depth map are relatively dense, and interpolation may thus not be necessary.

(5b) By comparing the height values at each pixel in the global depth map with the normal height range, the pixels in the global depth map are categorized into normal pixels and abnormal pixels.

The height values at the normal pixels fall within the normal height range, while the height values at the abnormal pixels fall outside the normal height range. The abnormal pixels may further be categorized into lower pixels (pixels with height values below the lower bound of the normal height range) and higher pixels (pixels with height values above the upper bound of the normal height range).

(5c) At least one pixel region representing the occupied region in the model reference map is determined. Each pixel region is typically in the form of a connected component, and each pixel in the connected component represents a corresponding location on the hot bed occupied by the first layer of the 3D model. It should be understood that different pixel regions representing occupied regions may have different areas. For the purpose of detection efficiency, detection may be performed only on some pixel regions with larger areas (e.g., greater than the threshold T₁) rather than all pixel regions.

(5d) For at least one of the at least one pixel region:

(5d-1) The number of normal pixels and the number of abnormal pixels among the pixels corresponding to the pixel region in the global depth map are tallied. For example, for each connected component C with an area greater than the threshold T₁, the number of normal pixels, the number of lower pixels, and the number of higher pixels (n_{g}, n_{b}, nᵣ) at the coordinates corresponding to the connected component C in the global depth map are tallied respectively.

(5d-2) The print quality result is determined based on the number of normal pixels and the number of abnormal pixels. For example, the number of normal pixels and the number of abnormal pixels are compared respectively with corresponding thresholds, and/or the relative quantity relationship between the normal pixels and the abnormal pixels is compared with the corresponding thresholds, and the print quality result is determined based on the comparison result. As previously described, the error between the target value and the actual value of the print height may be measured through various methods. Here, the number of normal pixels, the number of abnormal pixels, and the relative quantity relationship between the normal pixels and the abnormal pixels (e.g., the number of normal pixels is greater or less than the number of abnormal pixels, the ratio between the number of normal pixels and the number of abnormal pixels) are all measure criteria reflecting the error between the target value and the actual value of the print height. In an example, based on the number of normal pixels, the number of lower pixels, and the number of higher pixels (n_{g}, n_{b}, nᵣ), an error level l can be defined as follows:

$$l = \{ \begin{matrix}2 , if {n}_{b} > {T}_{nb 1} or {n}_{r} > {T}_{nr 1} or {n}_{g} < {T}_{ng} \\ max ( ( {n}_{b} > {T}_{nb 2} ) + ( {n}_{b} > N C \times {T}_{nb 3} ) , ( {n}_{r} > {T}_{nr 2} ) + ( {n}_{r} > N C \times {T}_{nr 3} ) , otherwise\end{matrix}$$

where T_{nb1}, Tₙᵣ₁, T_{ng}, T_{nb2}, T_{nb3}, Tₙᵣ₂>Tₙᵣ₃ are all thresholds, and NC represents the number of pixels in the connected component C. These thresholds may be pre-set or adaptive. For example, as a function of the number of pixels in the connected component C, these thresholds may adaptively change with the different numbers of pixels in the connected component C. In the example, the value of the error level I may be 0, 1, or 2. It should be understood that such error levels are merely illustrative rather than restrictive.

Based on the comparison result in operation (4a) or the number of normal pixels and the number of abnormal pixels in operation (5d-1), the print quality result may be determined in operation (4b) or (5d-2). Continuing with the above example regarding the error level l, the following decision logic may be defined:

If any connected component C has an error level of 2, the print quality result is decided as “Error”, and a final error level of 2 is output.

Otherwise, if there are two or more connected components with an error level of 1, and the total number of abnormal pixels (n_{b}+nᵣ across all connected components) is greater than the threshold T₄ or the proportion of abnormal pixels is greater than the threshold T₅, the print quality result is also decided as “Error”, and a final error level of 2 is output.

Otherwise, if there is one or more connected components with an error level of 1, the print quality result is decided as “Warning”, and a final error level of 1 is output.

Otherwise, the print quality result is decided as “Normal” with a final error level of 0.

It should be understood that such decision logic is merely illustrative rather than restrictive. In other embodiments, other decision logic may be applied. For example, the print quality result may be decided based on the cumulative absolute value of the error between the target values and actual values of the print height. It should be understood that knowing the error between the target values and actual values of the print height allows for the design of various possible decision criteria to detect print quality. While the present disclosure may not cover all possible decision criteria, it does not preclude other decision criteria from falling within the scope of the present disclosure.

In some embodiments, the print quality result may comprise a confidence level indicating the reliability of detection. The confidence level is a function of the number of pixels with height values in the global depth map and the total number of pixels in the model reference map. In the example, the confidence level is the ratio of the number of pixels with height values in the global depth map to the total number of pixels in the model reference map. In other examples, the confidence level may be other appropriate functions of the number of pixels with height values in the global depth map and the total number of pixels in the model reference map.

Under the influence of various system errors, the first-layer pattern actually printed may not necessarily align strictly with the first-layer pattern in the model reference map. Therefore, it may still be necessary to register the model reference map and the global depth map to identify errors at the best matching location. In some embodiments, prior to operation (5d), that is, prior to tallying, for the at least one of the at least one pixel region, the number of normal pixels and the number of abnormal pixels among the pixels corresponding to the pixel region in the global depth map, the global depth map may be registered with the model reference map, thus allowing the global depth map and the model reference map to be aligned according to a registration criterion.

In the embodiments, various registration methods may be used, such as:

(1) Template matching algorithm based on grayscale: Based on a known template image, a sub-image similar to the template image is searched for in another image. For example, the global depth map and the model reference map are binarized, and template matching is performed on the binarized global depth map and model reference map.

(2) Feature-based matching algorithm: Firstly, features are extracted from images, then feature descriptors are generated, and finally, based on the similarity of the descriptors, matches between the features of the two images are made. Image features may include points, lines (edges), and regions (areas), and may also be categorized as local features and global features.

(3) Relationship-based matching algorithm: Machine learning algorithms are used to match images.

In one example, a brute-force search method may be used to find the best matching location between the global depth map and the model reference map, and then the error is calculated at the best matching location. Specifically, the global depth map is moved in both the x and y directions, and the error is calculated at the new location. If the number of abnormal pixels at the new location is fewer than that at the previously recorded best location, then the new location is updated as the best matching location. To reduce the calculation, the search scope may be limited to a window range (e.g., 20 pixels, corresponding to a physical coordinate of 2 mm). Moreover, if the number of abnormal pixels at the new location is significantly higher than that at the previous location (e.g., by 20%), then the search in the current direction is stopped.

As previously described, the error between the target value and the actual value may be measured through various possible methods, thereby determining the print quality result. In some embodiments, determining the print quality result may comprise: inputting the model reference map, the print height set by the slicing software, and the global depth map into a trained machine learning algorithm (such as a classification neural network) to obtain the print quality result output by the trained machine learning algorithm. As previously described, the model reference map and the print height set by the slicing software indicate the target print heights at multiple different locations on the hot bed, while the global depth map indicates the actual print heights at the multiple different locations. Machine learning algorithms may be applicable to application scenarios where an error between the target value and the actual value of a print height is to be determined. In the case that there is a large number of training samples, a machine learning algorithm may be trained to detect the presence of printing defects.

FIG. 9 illustrates a structural block diagram of an apparatus 900 for detecting the print quality of a 3D printer according to an exemplary embodiment. The apparatus 900 comprises a first module 910, a second module 920, a third module 930, a fourth module 940, a fifth module 950, a sixth module 960, and a seventh module 970. For the purpose of discussion, the apparatus 900 is described below in conjunction with the 3D printer 100 of FIG. 1.

The first module 910 is configured to acquire a model reference map. The model reference map represents the occupied region of at least part of the first layer of a 3D model on the hot bed 110.

The second module 920 is configured to generate a scanning path based on the model reference map.

The third module 930 is configured to move the depth sensor 130 along the scanning path under the carriage of the printing head 120 and, obtain a first local depth map sequence based on measurements by the depth sensor 130 at the multiple different locations on the hot bed 110 during the movement.

The fourth module 940 is configured to print the first layer of the 3D model on the hot bed 110 using the printing head 120.

The fifth module 950 is configured to move the depth sensor 130 along the scanning path under the carriage of the printing head 120 and, obtain a second local depth map sequence based on measurements by the depth sensor 130 at the multiple different locations on the hot bed 110 during the movement.

The sixth module 960 is configured to generate a global depth map corresponding to the model reference map 510. The global depth map is filled with respective height values at multiple coordinates corresponding to the multiple different locations on the hot bed 110. The respective height values are the respective heights of the first layer of the 3D model at the multiple different locations and are the difference values between the various local depth maps in the first local depth map sequence and the corresponding local depth maps in the second local depth map sequence.

The seventh module 970 is configured to determine the print quality result based on the model reference map, the print height set by the slicing software for the first layer of the 3D model, and the global depth map. The print quality result indicates the print quality of the at least part of the first layer of the 3D model.

It should be understood that the various modules of the apparatus 900 shown in FIG. 9 may correspond to the various steps in the method 300 described with reference to FIG. 3. Accordingly, the operations, features, and advantages described above for the method 300 are equally applicable to the apparatus 900 and included modules thereof. For brevity, certain operations, features, and advantages are not reiterated here.

While specific functions are discussed above with reference to specific modules, it should be noted that the functions of the various modules discussed herein may be divided into multiple modules, and/or at least some functions of multiple modules may be combined into a single module. Executing an action by a specific module as discussed herein includes the specific module itself executing the action, or alternatively, the specific module invoking or otherwise accessing another component or module that executes the action (or executes the action in conjunction with the specific module).

Therefore, the specific module executing an action may include the specific module itself executing the action and/or another module that executes the action and is invoked by or otherwise accessed by the specific module.

It should also be understood that various techniques may be described herein in the general context of software hardware elements or program modules. The various modules described above with respect to FIG. 9 may be implemented in hardware or in hardware combined with software and/or firmware. For example, these modules may be implemented as computer program codes/instructions, which are configured to be executed in one or more processors and stored in computer-readable storage media. Alternatively, these modules may be implemented as hardware logic/circuits. For example, in some embodiments, one or more of these modules may be collectively implemented in a system on a chip (SoC). An SoC may include an integrated circuit chip (comprising processors such as central processing units (CPUs), microcontrollers, microprocessors, and digital signal processors (DSPs)), memory, one or more communication interfaces, and/or one or more components in other circuits. Moreover, SoC may optionally execute received program codes and/or include embedded firmware to perform functions.

According to the embodiments of the present disclosure, a non-transitory computer-readable storage medium storing instructions is further provided. The instructions are configured to cause the 3D printer 100, as described above, to perform the method described in any one of the embodiments of the present disclosure.

According to the embodiments of the present disclosure, a computer program product is further provided. The computer program product comprises instructions configured to cause the 3D printer 100, as described above, to perform the method described in any one of the embodiments of the present disclosure.

It should be understood that the various forms of processes shown above may be reordered, augmented, or reduced in steps. For example, the steps disclosed herein may be performed in parallel, sequentially, or in a different order, as long as the desired results of the technical solutions disclosed herein can be achieved. This document does not impose limitations in this regard.

While embodiments or examples of the present disclosure have been described with reference to the accompanying drawings, it should be understood that the methods, systems, and devices described above are merely exemplary embodiments or examples. The scope of the present disclosure is not limited by these embodiments or examples but is defined only by the claims as granted and equivalents thereof. Various elements in the embodiments or examples may be omitted or replaced by equivalent elements thereof. In addition, the steps may be performed in an order different from that described in the present disclosure. Further, the elements in the embodiments or examples may be combined in various ways. It is important to note that as technology evolves, many of the elements described herein may be replaced by equivalent elements that appear after the present disclosure.

What is claimed is:

1. A method for detecting the print quality of a 3D printer, wherein the 3D printer comprises a hot bed, a printing head movable relative to the hot bed, a depth sensor arranged on the printing head for measuring a distance of part of a region on the hot bed relative to the depth sensor, and at least one processor for obtaining a local depth map of the part of the region based on a measurement result from the depth sensor and controlling movement of the printing head relative to the hot bed based on control codes generated by slicing software to print a 3D model layer by layer; and the method comprises:
acquiring a model reference map, wherein the model reference map represents an occupied region of at least part of a first layer of the 3D model on the hot bed;
generating a scanning path based on the model reference map;
moving the depth sensor along the scanning path under a carriage of the printing head, and obtaining a first local depth map sequence based on measurements by the depth sensor at a multiple different locations during the movement;
printing the first layer of the 3D model on the hot bed using the printing head;
moving the depth sensor along the scanning path under the carriage of the printing head, and obtaining a second local depth map sequence based on measurements by the depth sensor at the multiple different locations during the movement;
determining a print quality result based on the difference values between various local depth maps in the first local depth map sequence and corresponding local depth maps in the second local depth map sequence, and a print height set by the slicing software for the first layer of the 3D model, wherein the print quality result indicates the print quality of the at least part of the first layer of the 3D model.

2. The method according to claim 1, further comprising,
generating a global depth map corresponding to the model reference map, wherein the global depth map is filled with respective height values at multiple coordinates corresponding to the multiple different locations, the respective height values being respective heights of the first layer of the 3D model at the multiple different locations, and being difference values between various local depth maps in the first local depth map sequence and corresponding local depth maps in the second local depth map sequence; and
determining the print quality result based on the model reference map, a print height set by the slicing software for the first layer of the 3D model, and the global depth map.

3. The method according to claim 2, wherein said generating the global depth map corresponding to the model reference map, comprises:
transforming multiple first coordinates representing the multiple different locations from the first local depth map sequence or the second local depth map sequence respectively to multiple second coordinates in a coordinate system where the model reference map is located;
generating a blank depth map in the coordinate system where the model reference map is located; and
filling the respective height values at the multiple second coordinates in the blank depth map to obtain the global depth map.

4. The method according to claim 1, wherein the model reference map and the set print height indicate target print heights at the multiple different locations; and wherein the determining the print quality result, comprises:
comparing the target print heights at the multiple different locations with the actual print heights at corresponding locations in the multiple different locations; and
determining the print quality result based on the comparison.

5. The method according to claim 2, wherein the determining the print quality result, comprises:
determining a normal height range of the first layer of the 3D model, with upper and lower bounds of the normal height range being related to the set print height;
by comparing height values at each pixel in the global depth map with the normal height range, categorizing the pixels in the global depth map into normal pixels and abnormal pixels, wherein the height values at the normal pixels fall within the normal height range, and the height values at the abnormal pixels fall outside the normal height range;
determining at least one pixel region representing the occupied region in the model reference map; and
for at least one of the at least one pixel region:
tallying a number of normal pixels and a number of abnormal pixels among the pixels corresponding to the pixel region in the global depth map; and
comparing the number of normal pixels and the number of abnormal pixels respectively with corresponding thresholds, and/or comparing a relative quantity relationship between the normal pixels and the abnormal pixels with the corresponding thresholds to determine the print quality result.

6. The method according to claim 5, wherein said determining the normal height range of the first layer of the 3D model, comprises:
determining a default height range based on the set print height, with upper and lower bounds of the default height range being a function of the set print height;
determining a set of pixels in the global depth map, with the set of pixels comprising all pixels with height values within the default height range;
calculating an average height value of the set of pixels; and
updating the upper and lower bounds by substituting the average height value into the function, with the default height range with the updated upper and lower bounds being the normal height range.

7. The method according to claim 5, wherein said determining the normal height range of the first layer of the 3D model, comprises:
determining the normal height range based on the set print height and calibration information of a printing material, wherein the calibration information of the printing material specifies a functional relationship between the upper and lower bounds of the normal height range and the set print height.

8. The method according to claim 5, further comprising, prior to categorizing the pixels in the global depth map into the normal pixels and the abnormal pixels:
performing interpolation on the global depth map to increase a number of pixels with height values.

9. The method according to claim 1, wherein the print quality result comprises a confidence level indicating the reliability of detection, wherein the confidence level is a function of a number of pixels with height values in a global depth map and a total number of pixels in the model reference map.

10. The method according to claim 5, further comprising: prior to tallying, for the at least one of the at least one pixel region, the number of normal pixels and the number of abnormal pixels among the pixels corresponding to the pixel region in the global depth map:
registering the global depth map with the model reference map, thus allowing the global depth map and the model reference map to be aligned according to a registration criterion.

11. The method according to claim 2, wherein said determining the print quality result, comprises:
inputting the model reference map, the set print height, and the global depth map into a trained machine learning algorithm to obtain the print quality result output by the trained machine learning algorithm.

12. The method according to claim 1, wherein the model reference map is generated by parsing control information generated by the slicing software, the control information comprising control codes used for printing the first layer of the 3D model; and wherein said acquiring the model reference map, comprises:
receiving the model reference map from a computing device communicatively connected to the 3D printer, wherein the model reference map is generated by the slicing software running on the computing device by parsing the control codes used for printing the first layer of the 3D model; or
reading the model reference map locally from the 3D printer, wherein the model reference map is generated by the at least one processor by parsing the control codes used for printing the first layer of the 3D model.

13. The method according to claim 1, wherein the model reference map is generated by parsing control information generated by the slicing software, the control information comprising layout information representing location and orientation of the 3D model on the hot bed; and wherein said acquiring the model reference map, comprises:
receiving the model reference map from a computing device communicatively connected to the 3D printer, wherein the model reference map is generated by the slicing software running on the computing device by parsing the layout information.

14. The method according to claim 1, wherein the occupied region comprises one or at least two discrete regions spaced apart from each other, and the model reference map comprises at least one pixel region respectively representing the at least one discrete region; and wherein said generating the scanning path, comprises:
determining respective bounding boxes for the at least one pixel region to obtain at least one bounding box respectively corresponding to the at least one pixel region; and
determining the scanning path in the model reference map, wherein a virtual box representing a field of view of the depth sensor moves along the scanning path to traverse an entire region of the at least one bounding box.

15. The method according to claim 1, wherein the occupied region comprises one or at least two discrete regions spaced apart from each other, and the model reference map comprises at least one pixel region respectively representing the at least one discrete region; and wherein said generating the scanning path, comprises:
determining respective connected components for the at least one pixel region to obtain at least one connected component respectively corresponding to the at least one pixel region;
determining a movement path in the model reference map for each connected component, wherein a virtual box representing a field of view of the depth sensor moves along the movement path to traverse an entire region of the connected component; and
merging the movement paths for all connected components into one merged path to serve as the scanning path.

16. An apparatus for detecting the print quality of a 3D printer, wherein the 3D printer comprises a hot bed, a printing head movable relative to the hot bed, a depth sensor arranged on the printing head for measuring a distance of part of the hot bed relative to the depth sensor, and at least one processor for obtaining a local depth map of the part of the hot bed based on a measurement result from the depth sensor and controlling movement of the printing head relative to the hot bed based on control codes generated by slicing software to print a 3D model layer by layer; and
the apparatus comprises:
a first module for acquiring a model reference map, wherein the model reference map represents an occupied region of at least part of a first layer of the 3D model on the hot bed;
a second module for generating a scanning path based on the model reference map;
a third module for moving the depth sensor along the scanning path under a carriage of the printing head, and obtaining a first local depth map sequence based on measurements by the depth sensor at a multiple different locations during the movement;
a fourth module for printing the first layer of the 3D model on the hot bed using the printing head;
a fifth module for moving the depth sensor along the scanning path under the carriage of the printing head, and obtaining a second local depth map sequence based on measurements by the depth sensor at the multiple different locations during the movement;
a sixth module for determining a print quality result based on the difference values between various local depth maps in the first local depth map sequence and corresponding local depth maps in the second local depth map sequence, and a print height set by the slicing software for the first layer of the 3D model, wherein the print quality result indicates the print quality of the at least part of the first layer of the 3D model.

17. A 3D printer, comprising:
a hot bed,
a printing head movable relative to the hot bed,
a depth sensor arranged on the printing head for measuring a distance of part of the hot bed relative to the depth sensor, and
at least one processor configured to obtain a local depth map of the part of the hot bed based on a measurement result from the depth sensor, and control movement of the printing head relative to the hot bed based on control codes generated by slicing software to print a 3D model layer by layer,
wherein the at least one processor is further configured to execute instructions to implement the method according to claim 1.

18. The 3D printer according to claim 17, wherein the depth sensor is a combination of a laser projector and a camera, the laser projector projects a laser onto the hot bed, and the at least one processor obtains a local depth map of the part of the hot bed illuminated by the laser based on an optical image of the projected laser on the hot bed captured by the camera.
